(19) United States
(12) Patent Application Publication
(10) Pub. No.: US 2003/0212611 A1
(43) Pub. Date: Nov. 13, 2003

(54) COMPUTERIZED FAMILY ADVISING SYSTEM AND METHOD FOR MAKING FUNERAL ARRANGEMENTS

(75) Inventors: John Christopher Barrott, Cincinnati, OH (US); Nancy Kay Koors, Villa Hills, KY (US); Charles Earl Day Jr., Aurora, IN (US)

Correspondence Address: DINSMORE & SHOHL LLP, ONE DAYTON CENTRE, SUITE 500, ONE SOUTH MAIN STREET, DAYTON, OH, 45402-2023, US

(73) Assignee: Aurora Casket Company, Inc., Aurora, IN (US)

(21) Appl. No.: 09/409,566

(22) Filed: Sep. 30, 1999

(51) Int. Cl. G06F 17/60

(52) U.S. Cl. 705/27

(57) ABSTRACT

### Abstract of the Disclosure

A computerized family advising system and method comprising a World Wide Web home page and associated script files for making funeral arrangements. The system is configured to allow families to gain knowledge and ask questions about every aspect of the funeral planning process. The system is also designed to help funeral directors, through a virtual showroom, both in the planning of at-need or pre-need funeral services and in allowing an increased inventory of funeral products. The system is a browser-based computer client application installed on a multimedia computer in a funeral home showroom, office or conference room. The system, if desirable, is accessible by a user through the Internet using any standard Internet browser. The system is capable of both recognizing user-initiated events and accepting user-defined queries in order to take a defined action and/or return queried funeral related information from a remote database.

### Detailed Description of the Invention

### Background of Invention

FIELD OF THE INVENTION

The present invention relates to a family advising system and method for making funeral arrangements. More particularly, the present invention relates to a computer software and system for assisting in making selections of pre-need or at-need funeral services and products.

Each year, Americans arrange more than two million funerals for family and friends. As such, one of the greatest issues facing providers of funeral services is dealing with families or friends of the deceased person that know very little about the products and services available to them. Typically, families and friends are often burdened with arranging a funeral service during a very stressful period that sometimes offers little time for making informed decisions. Under such pressured circumstances, the families and friends may be unable to find reliable, unbiased information about the available funeral services and products. Because funerals can cost thousands of dollars and because dozens of unanticipated decisions must be made quickly, choosing only those goods and services wanted or needed may be frustrating to such uninformed families and friends.

In arranging funeral services, most families or friends of the deceased person either stop by a funeral home or shop by phone to compare prices among funeral providers. However, obtaining only price information is problematic. First, finding out the cost of products and services over the telephone or in person can be intimidating, thereby possibly adding more stress to the already grieving family or friend. Second, a family member or friend calling or visiting a funeral provider may forget to ask about other funeral options, the terms, the conditions, and even the prices of funeral goods and services. Third, price lists fail either to provide reasonable answers to the questions that uninformed families and friends should be asking about the available funeral services and products or to enable funeral providers to present death care information in a sensitive and caring environment. Fourth, due to limited floor space in a funeral home, funeral providers have to select and choose which products to display, thereby limiting the selection of products from which a family or friend may browse and choose.

Therefore, there is a need for a system and method that will provide death care information to family members and friends of the deceased person in a sensitive and caring environment. Additionally, there is a need for a system and method that allows a funeral provider to inform families and friends about additional products not physical displayed on the showroom floor of the funeral home.

### Summary of Invention

The present invention provides a computerized family advising system and method for making funeral arrangements wherein a user is guided though a series of interactive electronic multi-media pages in order to make decisions on the proper funeral services and products desired. These series of interactive electronic pages allow the user to make further informational inquires about a particular funeral service or product and complete an ordering request. This ordering request, at the completion of the funeral arrangement process is then forwarded to a funeral products supplier for processing.

One object of the present invention is to provide a system and method that give family members and friends of the deceased person all the options available to them in both arranging funeral services and selecting funeral products in a sensitive and caring environment.

Another object of the invention is to allow a funeral provider to inform families and friends in a sensitive and caring environment about the available funeral services and additional products not physical displayed on the showroom floor.

Yet another object of the present invention is to provide a system and method for managing an inventory of funeral products of a distributor.

In order to achieve the foregoing objects, in the first instance the present invention is a computerized family advising system that presents an electronic home page and associated script files for making funeral arrangements. The system is configured to guide the user through the funeral planning process allowing the user to gain knowledge and to ask questions about several aspects of the funeral planning process before making planning decisions. Once the user has been guided through the planning process, a summary page is generated. This summary page shows an itemized list of the items and prices of all the choices that the user has made in arranging the funeral services and products while being guided through the planning process. The user has the option to accept, change or not accept those arrangement choices. Additionally, the system is also designed to help funeral directors with the planning of at-need or pre-need funeral services by allowing them to present the funeral arrangement information in a caring and sensitive environment. This planning can take place with either as much or as little interaction desired by the user. Further, through a "virtual" showroom, the system is designed to allow funeral providers to display an increased inventory of funeral products in order to meet the needs of a family or friend of the deceased person.

The system is a browser-based computer client application installed on a multimedia computer in a funeral home showroom, office or conference room. If desirable the application can be loaded on a laptop computer for a funeral professional to present in a client's family home. The client application resides on the funeral home computer and operates locally thereon. When necessary, the client application communicates, via dial-up modem access or Internet access, to a remote system server computer. The system server computer manages the control and availability of an existing inventory of funeral products available from a distributor. Such communication is performed both to update the pricing and the availability of existing and new products of a resident inventory list on the computer at the funeral home, and to order inventory from the distributor.

The system is used either "pre-need" by a person making funeral arrangement before death or "at-need" by a family or friend for a deceased person both to view options and to select funeral services (e.g., burial, cremation, embalming, etc.) and products (e.g., casket type, urn selection, etc.). The system is capable of both recognizing user-initiated events and accepting user-defined queries in order to take a defined action and/or return queried funeral related information from a remote system server's database. Additionally, the user through the Internet, using any standard Internet browser, may access the system of the present invention remotely so that an individual can operate the system from the comforts of home.

The family advisor system guides the user through a series of questions with choices to determine, generally, which services are of an interest to the individual. Additionally, the system allows a funeral provider to show funeral products without requiring the funeral home to maintain an actual showroom (e.g., having caskets displayed) in the funeral home. Further, the system allows the user to view and select product options (i.e., urn or casket style, material, interior fabric and theme) by selecting from a number of pre-determined check boxes. After viewing and selecting, the system filters the available products and services using the user's selected choices to provide the user with a list meeting the individual's specification. The products and services may thereafter be canceled, revised or ordered.

The client application communicates with the server, generally, at two instances. The first instance is at start-up when the server is queried to determine which products and services are available and in stock. The distributor's inventory data is only accessible in the read only mode. The second instance is when the order is placed to reserve the products and services. Order information is limited to restricted directories on the server in a "write only" mode. This gives the system the ability to add data to the distributor's database without the ability of other system users to read any other customer's data.

In a second instance, the present invention is a method for arranging funeral services and products. In this method a computer having a memory device for storing information, a keyboard for entering information, a display terminal for displaying visual information related to funeral services and products, a pointing device for selecting visual objects display on the display terminal, a speaker system for listening to audio information related to funeral services and products, and a communication device for connecting to a remote server database of a distributor of funeral products, is used for presenting, searching, selecting and maintaining funeral arrangement information contained in a database provided by a funeral products distributor. A computer application running on the computer presents to a user a selectable options page for funeral arrangements, which provide various user selectable actions. The user can select these options or choices either by keyboard actions or by the pointing device. After selecting an option regarding the type of funeral arrangement generally interested in, the user is then guided through additional selectable option pages. These additional selectable option pages are design to provide information on the available funeral services and products and to enable the user to narrow down a selection of available services and products, thereby allowing the user to choose those services and products that meet the user's needs. After making a decision of the services and products wanted, the computer with the necessary script command compiles from a database a summary list of desired funeral arrangements based on the user's selections. This summary list is then provided to the user and, if accepted, a products list based on the user's selections is forwarded to a distributor for processing and shipping.

Further objects, features and advantages of the present invention will become apparent from a consideration of the following description and the appended claims when taken in connection with the accompanying drawings.

### Brief Description of Drawings

FIG. 1 is a schematic block diagram of the system of the present invention;

FIG. 2 is a pictorial page view of a HTML home page of the present invention;

FIGS. 3 and 4 are pictorial page views of HTML form pages of the present invention for entering and retrieve information from a database, and for guiding a user through the funeral arrangement process;

FIGS. 5a, 5b, and 5c are pictorial page views of HTML information pages of the present invention for providing information in the form of text, pictures and video clips giving more detailed information about funeral services and products;

FIG. 6a and 6b are pictorial page views of HTML summary pages of the present invention for providing summary information about the services and products selected by a user;

FIG. 7a is a pictorial page view of a HTML password page of the present invention for protecting parts of the application made inaccessible to a user without a password;

Fig. 7b is a pictorial page view of a print window for a printable products list of the present invention;

FIG. 8 is pictorial page view of a HTML protected page of the present invention for a services maintenance module of the software application;

FIG. 9 is pictorial page view of a HTML protected page of the present invention for a products maintenance module of the software application;

FIGS. 10a and 10b are pictorial page view of HTML protected pages of the present invention for a customer's maintenance module of the software application;

FIG. 11 is pictorial page view of a HTML protected page of the present invention for a cash advance module of the software application;

FIG. 12 is pictorial page view of a HTML protected page of the present invention for a setup module of the software application;

FIG. 13 is pictorial page view of a HTML protected page of the present invention for a shipping addresses module of the software application;

FIGS. 14a and 14b are pictorial page view of HTML protected pages of the present invention for an Order/Update module of the software application; and,

FIGS. 15-17 depict architectural blueprints of the present invention of a path that a user takes through a funeral arrangement process, and how HTML pages of the present invention link and relate to one another.

### Detailed Description

In the following detailed description of the preferred embodiment, reference is made to the accompanying drawings, which form a part hereof and in which is shown by way of illustration of a specific embodiment in which the invention may be practiced. This embodiment is described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense as the scope of the present invention is defined by the appended claims.

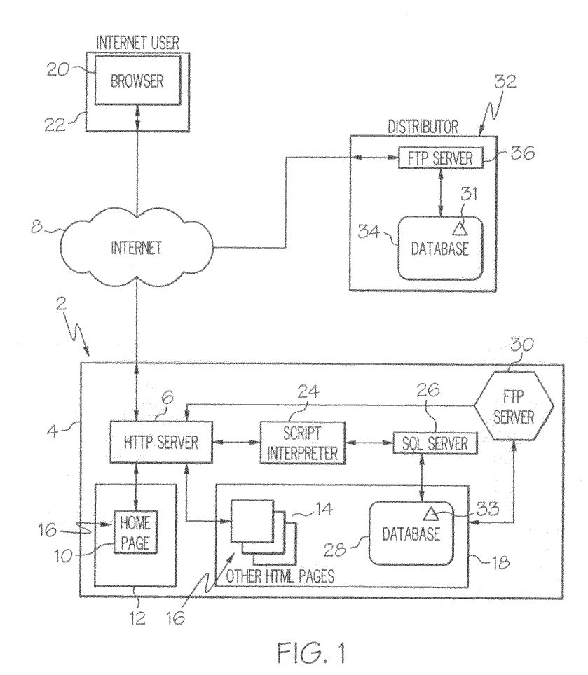

FIG. 1 illustrates generally a family advising computer system 2 family advising computer system 2 for arranging funeral services. The computer system 2 is running an Internet (World Wide Web) the application 4 application 4 that provides a Hyper Text Transfer Protocol (HTTP) server 6. The HTTP server 6 HTTP server 6 is an input/output interface that establishes and manages the connection of application 4 to the Internet 8 Internet 8 for both local and remote users. To provide the input/output interface into the family advising system 2, the HTTP server 6 presents to a user an electronic home page 10. For a local user, the home page 10 home page 10 is display by a local browser 12 local browser 12 that is provided by the application 4.

The home page 10 contains multiple lines of code or tags (not shown) written in Hyper-Text Markup Language (HTML). It is to be appreciated that HTML is a simple, universal mark-up language integrated into an electronic text document that allows Internet publishers to create complex multimedia pages of text, images, sound and video that can be viewed by anyone else on the Internet 8, regardless of what kind of computer or browser is being used. Additionally, HTML documents, known as web pages, present hot spots to a user, which when selected by the user with a mouse pointer activate functions to which the hot spots represent. The HTML tags that are embedded on the page and hidden from a viewer with a browser define these functions. One of the functions that HTML tags perform is to point to other HTML pages, generally indicated by 14, thus allowing a user to navigate through a defined set of HTML pages, called a site 16. The site 16 of application 4 contains the home page 10, the additional HTML pages 14, and tagged multimedia files (not shown) that are pointed to by additional hot spots provided on some of these HTML page 14, and is stored on a local drive 18 to which the HTTP server 6 has access.

To view the home page 10 the local browser 12 or a remote browser 20, running on a remote user computer 22 that is connected to the Internet 8, asks the HTTP server 6 to send the home page 10. After receiving the home page 10 the HTML tags (not shown) tell the browser 12 or 20 what to do, what is on the page, and how the page should be displayed. Once the user has accessed the home page 10, the application 4 will guide the user through the site 16 to both help arrange a funeral and provide, when requested, detailed information about the funeral care process.

In the present invention some of the additional HTML pages 14 allow the entering and processing of information by the system 2. These types of HTML pages are called HTML form pages, which contain input tags (not shown) that enable information to be sent to the HTTP server 6 for further action. When the browser 12 or 18 sees these input tags it knows that the user can enter data that will require further action.

A form page when displayed by a browser 12 or 20 generally shows an assortment of text entry boxes, drop-down boxes, radio buttons, and check boxes, by which the user can enter information into the hidden input tags. After a user enters information into the provided input boxes on the form page, a hot spot or button when clicked instructs the browser 12 or 18 to post the information contained in the input tags back to the HTML server 6. The HTTP server 6 analyses the incoming data and looks for an identifier tag (not shown) telling it what program will deal with the request. The HTTP server 6 accomplishes this task by passing a hidden script file (not shown) provided on the HTML page to a script interpreter 24. The script interpreter 24 extracts the information from the form tags and passes that information to the proper program as instructed by the script file such as to a SQL server 26. It is to be appreciated that the script file is nothing more than an instruction or a set of instructions telling the script interpreter 24 to do something. For example, a script file may instruct the script interpreter 24 to have the SQL server 26 to write the passed information to a database 28 stored on the local drive 18. Additionally, the script file could instruct the script interpreter 24 to request information from the database 28, in which case the SQL server 26 extracts the requested information and then passes the queried information back to the HTTP server 6 for presentment to the browser 12 or 20.

Further shown by Fig. 1, is an FTP server 30, which allows the family advisor application 4 to upload and download data files 31 and 33 between a distributor's system, generally indicated by 32. The distributor's system 32 generally comprises of a remote database 34 and a remote FTP server 36 for linking with the FTP server 30 of the application 4 to establish an FTP session. Establishing a FTP session requires logging on to the distributor's system 32 in the same way that a user logs in to a local network or ISP. Once an FTP session is established, data files 31 and 33 are preferably transferred between the remote FTP server 36 and the FTP server 30 of the family advising system 4 via the Internet 8. However, it is to be appreciated that a direct-dial up using a modem (not shown) could also be used to transfer files if desired.

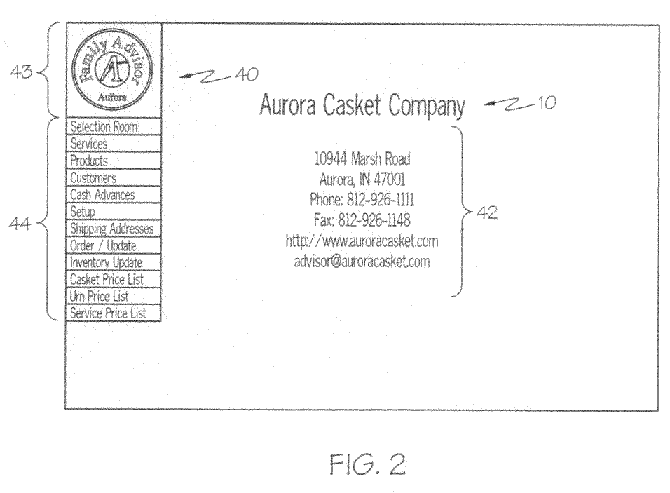

Figs. 2-14, illustrate examples of the types of HTML pages 10 and 14 that are available for viewing on the site 16 of the system 2 by a user. Fig. 2 depicts a preferred home page 10 of the present invention, which provides a navigation toolbar 40 and contact information 42 of a funeral provider. The navigation toolbar 40 includes an application logo 43 and user-selectable hot spots or hot buttons 44. Hot buttons 44 represent HTML tags that each points to a particular HTML page, thereby allowing a user to navigate to and from different pages available on the site 16.

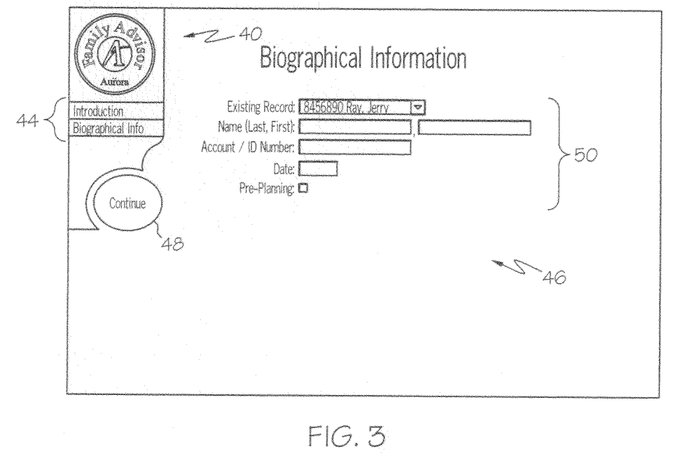

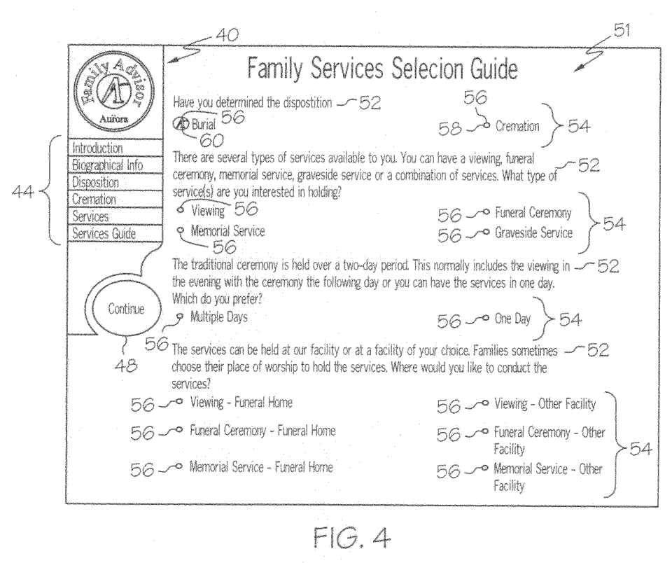

Figs. 3 and 4 illustrate two types of preferred HTML form pages used by the application 4 to input information into the system 2 for action. As depicted, the user-selectable hot buttons 44 on navigation toolbar 40 differ between Figs. 2 and 3. It is to be appreciated that hot buttons 44 of navigation toolbar 40 dynamically change with each newly display HTML page to indicate to the user which HTML pages are navigable too from the currently shown HTML page. For example, from the form page 46 illustrated by Fig 3, the user can only return to the home page 38 or continue to the next linked page, via a tag represented by a hot spot or continue button 48. Further provided on this form page 46 are input boxes 50, which as explained above, allow a user to enter information into the input tags hidden on the page from the user.

Fig. 4 depicts the preferred format of a form page 51 used to guide a user through the funeral process. A series of questions 52, each with set choices 54, are presented to the user for answering. Each of the set choices 54 has an associated radio button 56 that allows the user to indicate a preference for funeral services and products. As shown, the radio button 56 has two states either unflagged 58 or flagged 60. If radio button 56 is in the flagged state 60, a HTML tag pointing to a script file is enabled. The script file once enable can be ordered to run after the user clicks the continue button 48, or at a later defined timed.

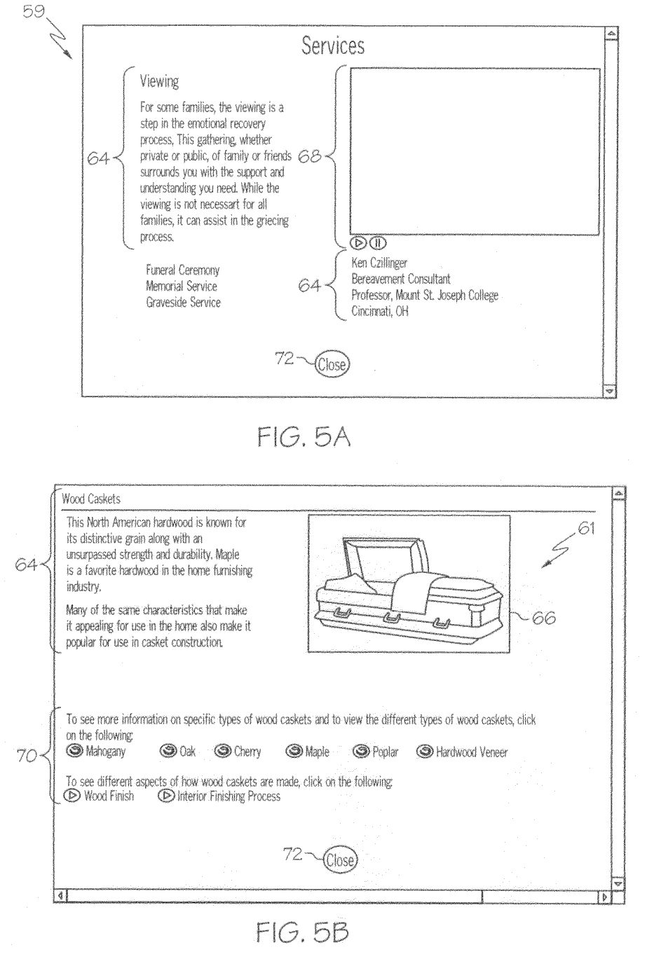

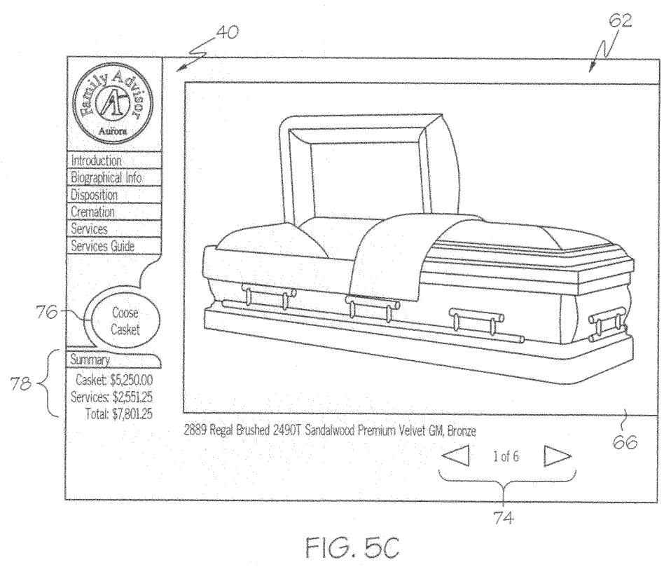

Figs. 5a-5c illustrate examples of preferred HTML information pages 59, 61, and 62, respectively, of the present invention. The HTML information pages 59, 61, and 62 contain text 64 (Figs. 5a and 5b), pictures 66 (Figs. 5a and 5c), and a video clip 68 (Fig. 5b). Additionally, to navigate to other HTML pages 14 within the site 16 of the application 4 from these pages, provided are additional information selection buttons 70 (Fig 5b), a close button 72 (Fig. 5a and 5b), which brings a user back to the previously viewed page, and forward and back buttons 74 (Fig. 5c) for viewing a series of pictures 66 from the HTML information page 62. Further, as depicted by Fig 5c, this information page 62, as do some other HTML pages 14, includes an item choose or selection button 76 on the navigation toolbar 40 for adding the item to a purchasing list. Also, an information box 78 on this page 62 is designed to display a running price summary for the products and services selected at that point in the funeral process. This running price summary allows the user to select preferences, see their immediate monetary effect thereby allowing the user to adjust those choices accordingly.

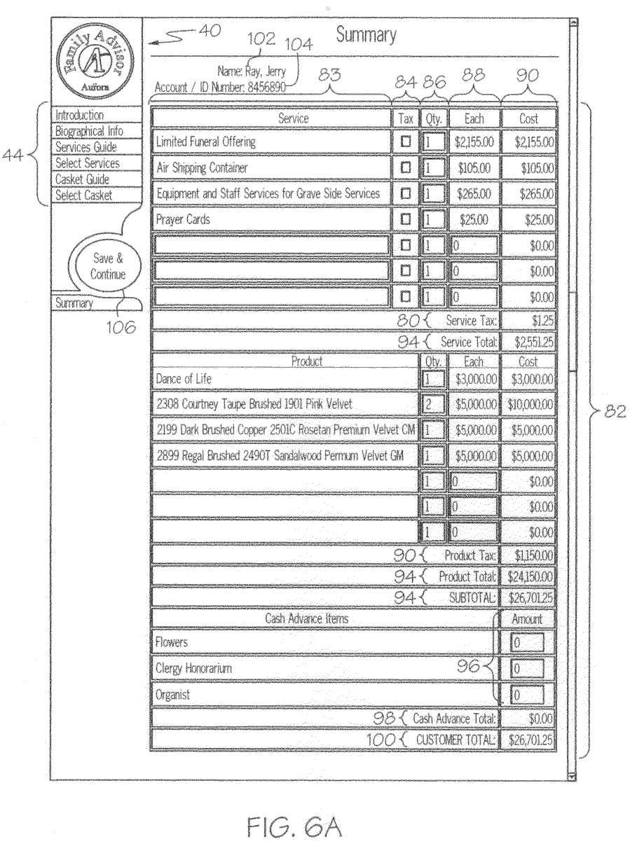

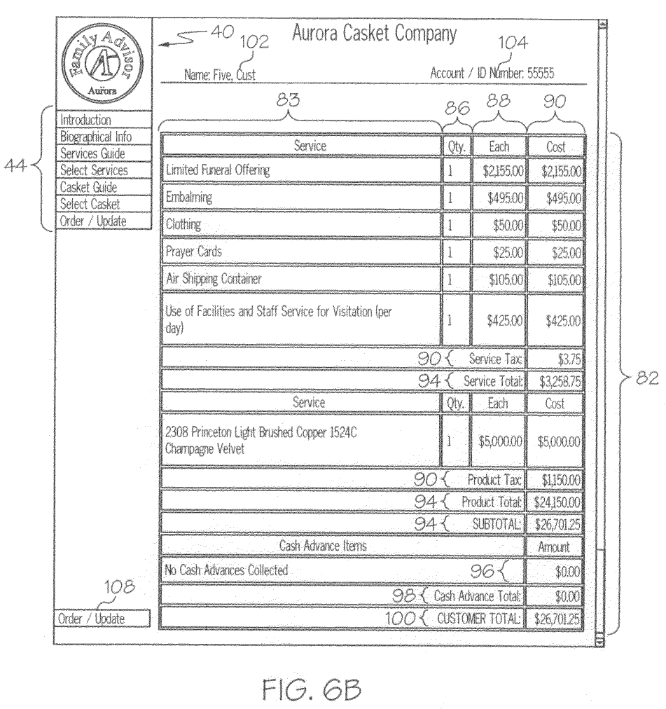

Figs. 6a and 6b depict preferred HTML summary pages 80 and 81 of the present invention that provide summary information, in editable categories, generally indicated by 82, on user selected services and products. The editable categories 82 listed include a name 83 for the service or product selected, tax indicator 84, quantity 86, individual price 88, cost 90, tax 92, sub-total price 94, cash advance amount 96, cash advance total 98, and customer total 100. Additionally, shown on the summary pages 80 are a user name 102 and an account/ID number 104. s illustrated by Fig. 6a, the navigation toolbar 40 provides a save & continue button 106 for saving the selection to the file 33 on the local drive 18 and for moving onto the next page. The summary page illustrated by Fig. 6b includes an order/update button 108 for forwarding, via an FTP session, the product-ordering information from the file 33 to the distributor"' system 32 for further processing.

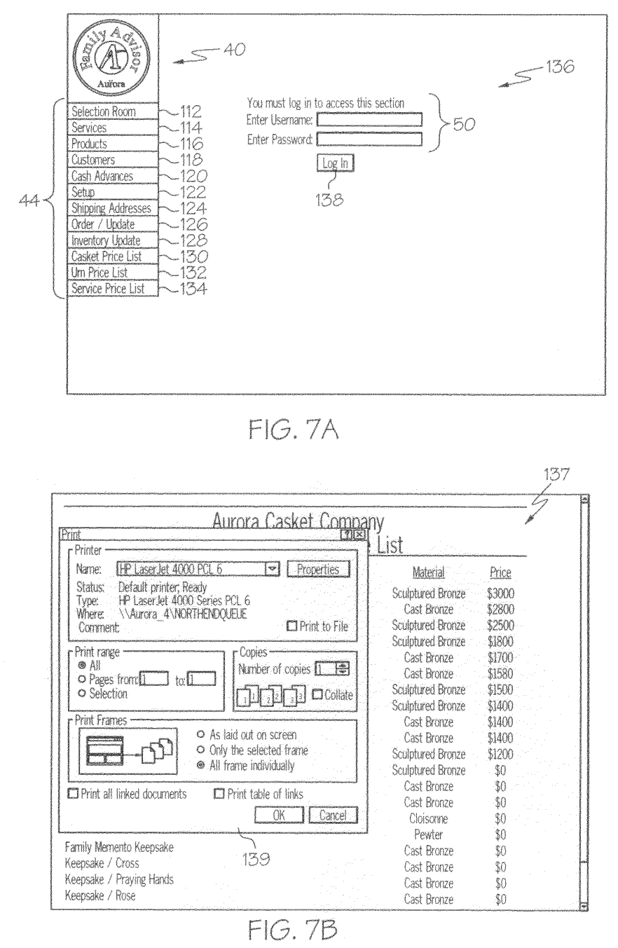

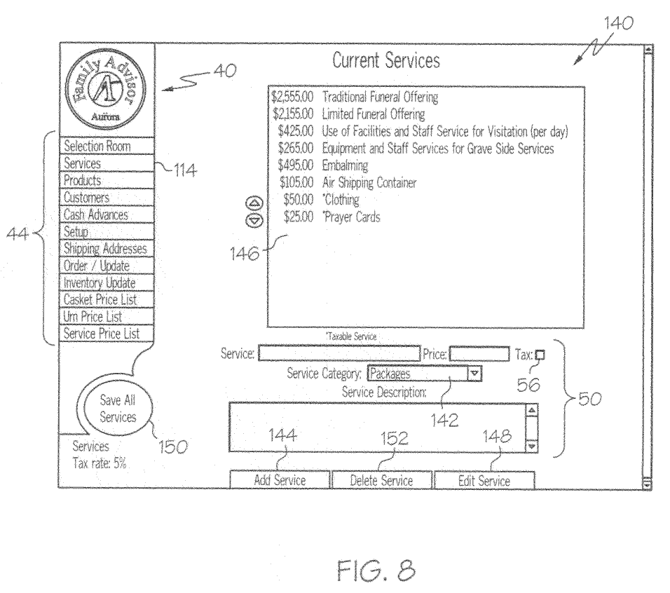

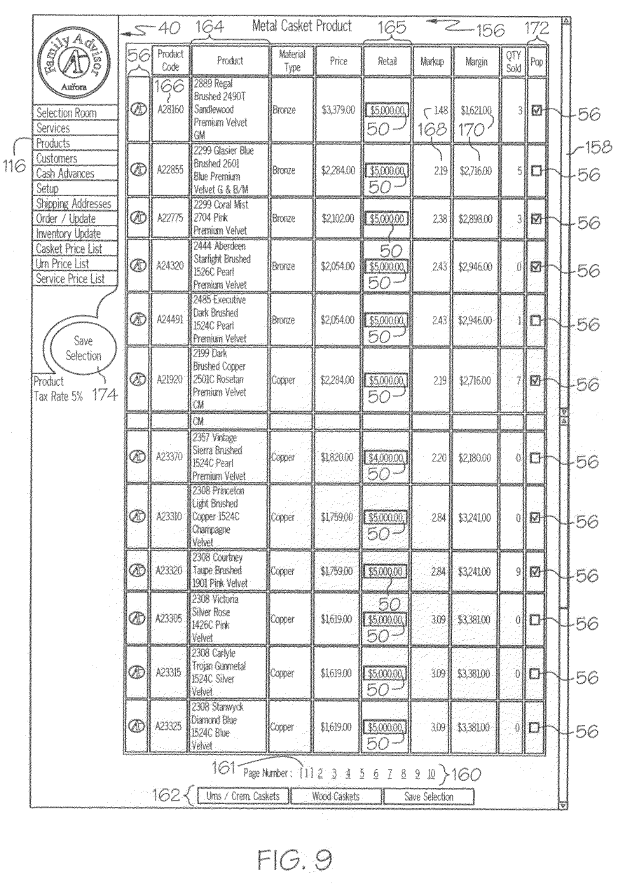

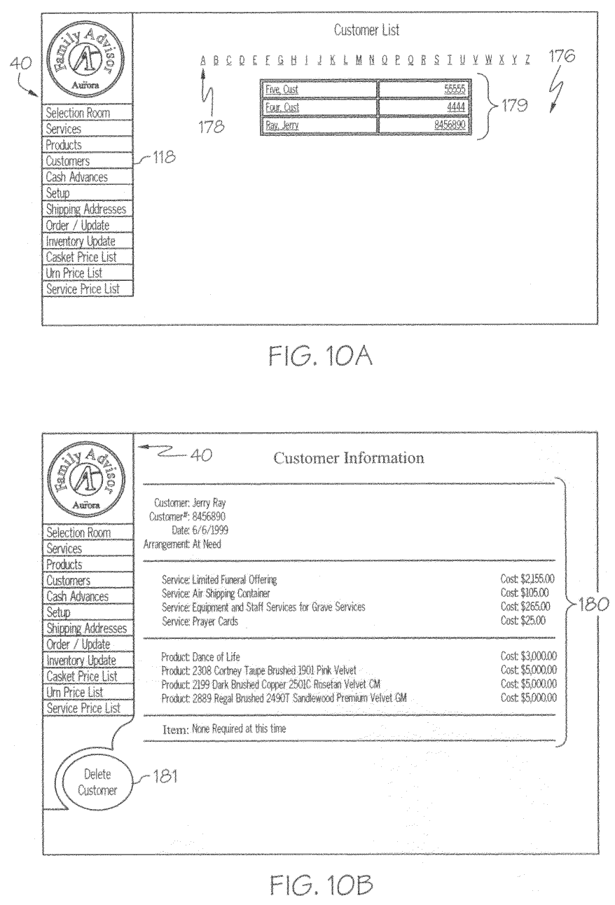

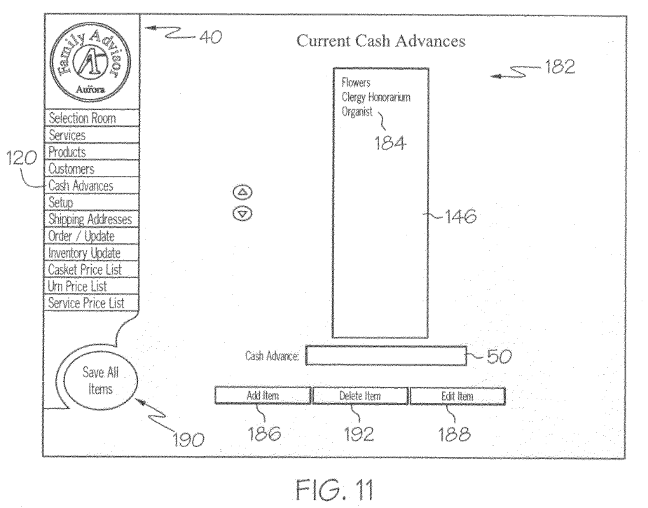

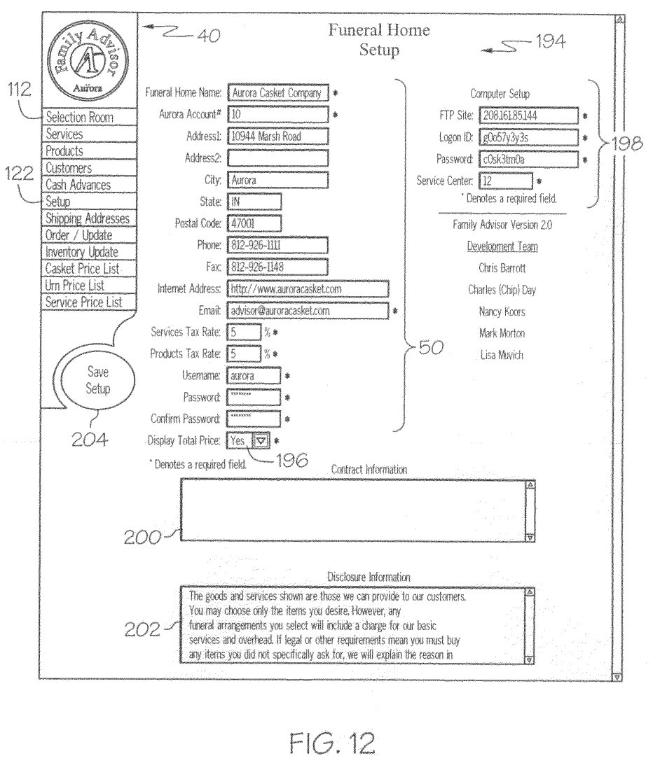

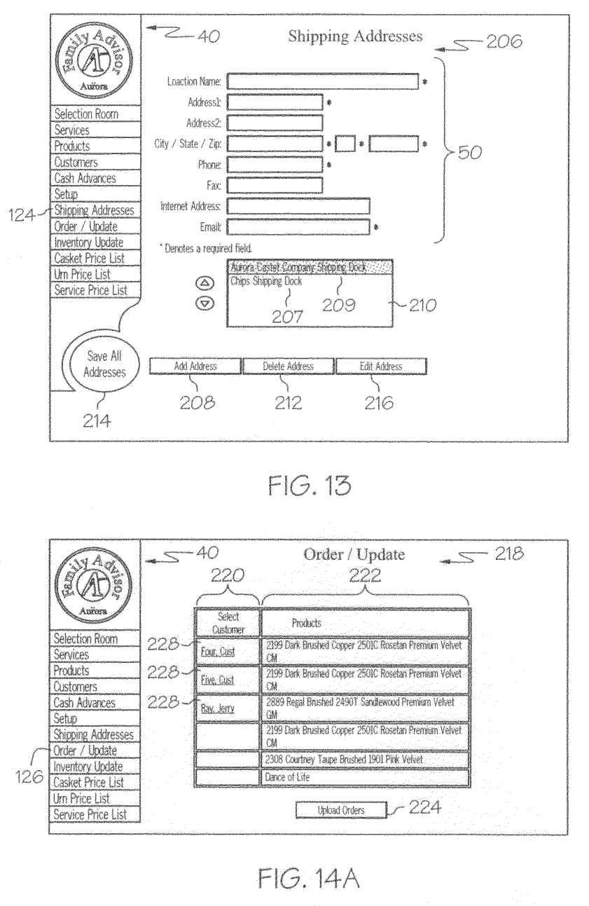

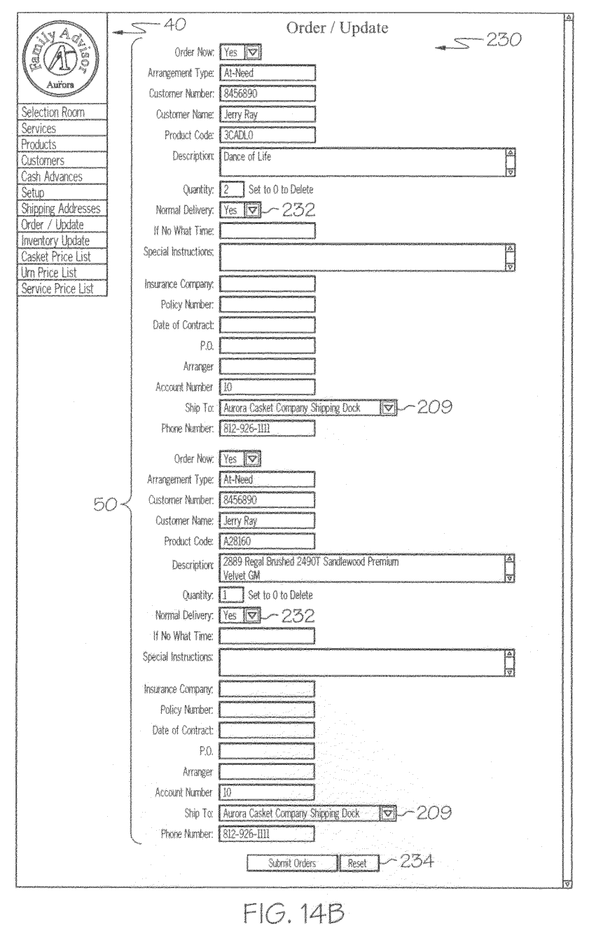

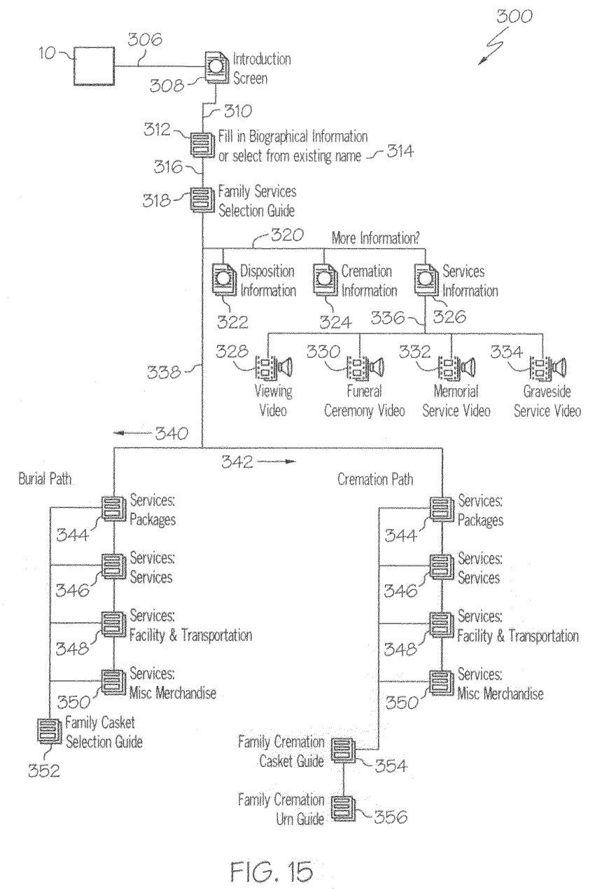

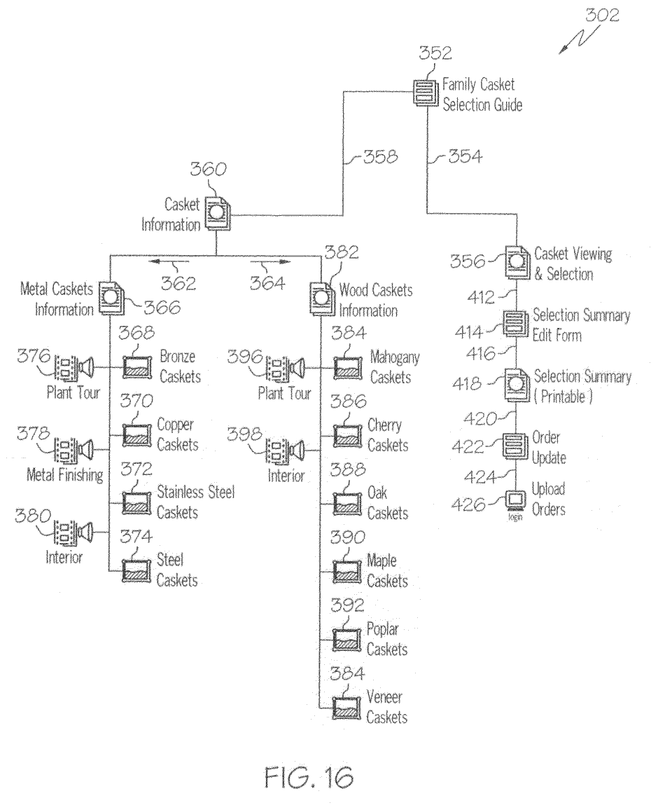

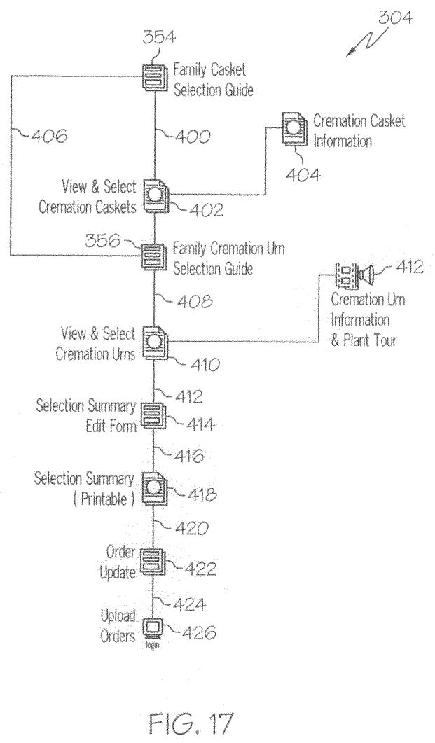

Referring to Fig. 7a, illustrated is a password page 136 from which areas of the application 4 are made accessible to a user with a password. These protected areas include services administration, product administration, a cash advance area, a system setup area, and a shipping addresses area. It is to be appreciated that a privilege user accesses these protected areas from selecting one of the hot buttons 44 on the navigation toolbar 40 when provided on an HTML page within site 16. As illustrated by Fig. 7a, the hot buttons 44 provided include a "Selection Room" button 112 which the user first selects in order to be guided through the funeral arrangement process, a "Services" button 114 to navigate to a "Current Services" page (Fig. 8) for services administration, a "Products" button 116 to navigate to a "Products" page (Fig. 9) for products administration, a "Customers" button 118 to navigate to a customer list summery page (Fig. 10a), a "Cash Advances" button 120 to navigate to a cash advance page (Fig. 11), a "Setup" button 122 to go to a system setup page (Fig. 12), a "Shipping Addresses" button 124 to navigate to a shipping addresses page (Fig. 13), an "Order/Update" button 126 to view an order/update administration page (Fig. 14a), and an "Inventory Update" button 128 to perform an inventory update function.

The inventory update function is used when a funeral director is about to do an at-need arrangement with a family while utilizing the system 2. Selecting the inventory update button 128 causes that system 2 to perform an online inventory check, via a FTP session, with the distributor"' system 32 (Fig. 1). Performing the online inventory check will adjust available product-offerings so that a user of the funeral process system 2 will be unable to view any out of stock items. For an individual requiring an at-need arrangement, clicking on the "Inventory Update" button 128 on the toolbar 40, will cause the system 2 to automatically dial into the distributor"' inventory system 32 and download an update inventory file 31. The privilege user views this file transfer from a FTP session window (not shown). Once the update inventory file 31 is downloaded into the system 2, the application 4 will update the current inventory display listing accordingly. The privilege user will then be returned to the home page 10 after the FTP session is completed.

It is to be appreciated that a system administrator and not the user, will have access to those above-mentioned protected pages. Accordingly, any user selecting one of the above-mentioned protected pages of the application 4 is presented with the password page 136. The system administrator or privilege user, after entering both an authorized name and a password into the provided input boxes 50, clicks on a log in button 138 to gain entry to the protected page selected from the navigation toolbar 40. It is to be appreciated that access to these protected pages allows the privilege user to customize the information presented by the application 4 on the browser 12 or 20 to a user. A discussion of each of these protected pages follows hereafter.

Further, shown on the navigation toolbar 40 of Fig. 7a is a "Casket Price List" button 130, an "Urn Price List" button 132, and a "Service Price List" button 134. It is to be appreciated that funeral homes are required by the Federal Trade Commission to provide price lists to funeral consumers during the funeral arrangement conference. The system 2 makes it easy for funeral directors to print out price lists corresponding to the products and services that the funeral home provides. To print out a particular price list, as illustrated by Fig 7b, a user simply clicks on one of the price list buttons 130, 132, and 134 provided on the toolbar 40. A price list 137 will then generate, opening a printing window 139, which allows the user to print the price list on an attached printer (not shown) of the system 2.

SERVICES ADMINISTRATION

Fig. 8 shows a preferred form page, identified as a "Current Services" page 140. From the "Current Services" page 140, funeral directors can customize how their service offerings are displayed to a user of the funeral advising system 2. Accordingly, a privileged user can access this area by clicking on the "Services" button 114 located on the toolbar 40 provided on either the home page 10 or any other page 14. The privileged user is then prompted for a user name and a password by the password page 136 (Fig. 7). Once password authentication has take place, via a script file comparing entered information against a user password file on database 28, the privileged user is presented with the "Current Services" page 140. In this area, the privilege user can enter all service information. To enter a new service, the privileged user clicks into the input boxes 50 and types in the name, price and description of the service. Next the privileged user signified if the service is a taxable item by clicking the "Tax:" radio button 56, and from a drop down box 142 selects one of the provided service type options. Once this is completed, the privileged user clicks on an "Add Service" button 144 and the new service will be added to a list file displayed in a file list box 146 provided on the page 140. It is to be appreciated that the file list box 146 is another feature provided on a form page of the present invention to display and customize information contained in the files 33 that are store on local drive 18.

Clicking on the desired service listed in the file list box 146, then clicking on an "Edit Services" button 148 edits the services. A privilege user after making the desired modifications, then clicking on a "Save All Services" button 150, which updates the services list file, which is one of the files 33 stored on local drive 18. Clicking on the desired service in the file list box 146, then clicking on a "Delete Service" button 152 allows a privilege user toll remove the selected service from the list displayed. Once all modifications have been made to the file list, the privilege user clicks on a "Save all Services" button 154 to save the file list to the database 28.

PRODUCTS ADMINISTRATION

Fig. 9 depicts a forms page, identified as a "Products Selection" page 156, from which Funeral Directors can modify their product offerings and the retail pricing that is viewed by a user. To enter the products administration area, a privilege user clicks on the "Products" button 116 on the toolbar 40 provided on a HTML page of site 16. After passing through the password page 136 (Fig. 7), the privileged user is displayed the "Product Selection" page 156 that list all products contain in a products list file, which is one of the files 33 on the local drive 18. In this products administration area the privilege user navigates by scrolling up or down each page, using a scroll bar 158, clicking on one of the page numbers 160, where the current page is indicated by a bolded bracketed number 161, or clicking one of the product type buttons 162. Clicking on the radio buttons 56 will indicate a flagged condition 60. As such, all products list in a products column 164 with a flagged condition 60 is displayable to a user going through the funeral process. The privilege user while on this page 156 may view a picture 66 of any product 164 by clicking on a corresponding product code 166 for each product. It is to be appreciated that the update file 31 from the distributor's system 32 provides the listed products 164 and their associated information (name, picture, material type, and product code), in which only the individual or retail price 88 are modifiable.

To enter in a desired retail price in retail column 165 for each product listed in the products column 164, the privilege user clicks into the "Retail" input boxes 50 and types in a desired retail price. Based on the entered retail values the system 2, by running a script file, will automatically calculate and return a "Markup" ratio 168 and a "Margin" value 170 for each product listed in the products column 164. To designate a particular product to be displayed as a "Most Popular" unit to a user in a products selection room HTML page (not shown), the privilege user clicks on the radio button 56 in the "Pop" column 172 for the desired product. Once all modifications have been made on the products inventory page 156, the privilege user clicks on a "Save Selection" button 174 located on the toolbar 40 to save the products inventory file to the local drive 18.

CUSTOMER DATABASE

Figs. 10a and 10b are illustrations of HTML summary pages that display information from customer records. It is to be appreciated that Funeral Directors can access the transaction history of any prior clients that they have entered into the system 2. A "Customers" database file is part of the database 28 on local drive 18, which keeps summary information of all services and products offered by a funeral provider. The privilege user can also use this area to convert pre-need registrations in the customer database file to at-need product orders. The "Customers" database file can be accessed from the home page 10 or from any other page 14 by clicking on the "Customers" button 118 on the toolbar 40. All customer names will appear on a first customer summary page 176 (Fig. 10a). The privilege user can either scroll up or down this list, or click on the corresponding letter hot spot 178 that represents the first letter of the client's last name to get an alphabetical listing 179 of last name, first name and customer ID number of all current customers. To display a particular customer's information record 180, illustrated by Fig. 10b, a privilege user clicks on the name in the alphabetical listing 179 and a script file will run that accesses the information from the customer file stored on the database 28, and return the customer's information record 180. It is to be appreciated that to convert a pre-need registration to an at-need order, the privilege user opens the customer information record 180, and if it is a pre-need record a "Change-to-At-Need" button (not shown) will be displayed on toolbar 40. The privilege user clicks the "Change to At-Need" button (not shown), and then clicks "Yes" when the "Confirm Change" pop-up box appears (not shown) to complete the update from pre-need to at-need. After clicking the "Confirm Change" button the privilege user will be presented with an "Order/Update" page (Fig 14), which is discussed later. To delete the customer for the database 28, the privilege user clicks on the "Delete Customer" button 181 on toolbar 40, which runs a script that removes the record from the database 28.

CASH ADVANCE ADMINISTRATION

Fig. 11 illustrates a form page, entitled "Current Cash Advances," from which Funeral Directors may classify items that vary in price daily as cash advance items. The family advisor system 2 allows Funeral Directors to customize their cash advance items 182 contained in one of the files 33 (Fig. 1). To access this cash advance maintenance area, click on the "Cash Advances" button 120 on the toolbar 40 of an HTML page on site 16. After entering a proper password on password page 136, the privilege user is displayed the "Current Cash Advances" form page 182. This page 182 allows the privilege user to input cash advance items 184 by clicking in the "Cash Advance:" input box 50 and typing in the name of the cash advance item. Once the cash advance item 184 is completed, the user clicks on an "Add Item" button 186 and that cash advance item 184 will be added to the cash advance list file. To edit an existing cash advance item 184, the privilege user simply clicks on the desired cash advance item 184 shown in the file display box 146 so that it is highlighted, and then clicks on the "Edit Item" button 188. To save the changes, the user clicks on a "Save All Items" button 190 on the navigation toolbar 40, which runs a script that saves the changes to the cash advance list to the database 28. Lastly, to delete a cash advance item 184, the user clicks on that item listed in the list box 146 so that it is highlighted, and then clicks on a "Delete Item" button 192 to run a script that removes the item from the cash advance list.

SETUP MAINTENANCE

Fig. 12 illustrates a form page used to setup the system 2 called a "Funeral Home Setup" page 194. All of a funeral home's initializing data is inputted from the funeral home setup page 194 into the system 2 for proper operation of the application 4, as well as, for customizing the appearance of home page 10. To access the setup maintenance area, a privilege user clicks on the "Setup" button 122 on the toolbar 40 either from the home page 10 or from any other page 14. It is to be appreciated that the first time the application 4 is ran, the home page 10 (Figs. 1 and 2) will be blank except for the toolbar 40. After clicking on the "Setup" button 122, the user will be prompted to enter a user name and a password by the password page 136 (Fig. 7). After entering the proper user name and password information, clicking on the "Log In" button 138 will take the user to the "Funeral Home Setup" page 194. The user then populates the application 4 with the necessary information by typing the data into the provided input boxes 50. Any of the setup text boxes 50 that have an "*" next to them must be filled in with the proper information in order for the application 4 to work properly. The "Display Total Prices" category has a pop-up box 196 that instructs the application 4 whether or not to display in the summary information box 78 service and total funeral cost information when viewing products on a product selection information page 62 (Fig. 5c). If "No" is selected in the pop-up box 196, then only the retail product price will be displayed on the product selection information page.

Additionally provided on the setup page 194 are computer FTP access information input boxes 198. These input boxes 198 enable the application 4 to communicate with the distributors system 32 via an FTP session. Further depicted on the setup page 194 is "Contract Information" input box 200 and "Disclosure Information" input box 202. To add information into either of these input boxes 200 and 202, the privilege user clicks into the input boxes 200 and 202, one at time, and types or "cut and pasted" from other Microsoft® based documents having the desired information. Once all changes have been made to the setup page 194, the privilege user then clicks on the "Save Setup" button 204 on the toolbar 40, which saves the setup to one of the files 33 stored on the local drive 18.

SHIPPING ADDRESSES MAINTENANCE

Fig. 13 illustrates a form page used to input shipping addresses for funeral homes that have multiple locations, known as "Shipping Addresses" page 206. To set up and maintain a list of shipping addresses, click on the "Shipping Addresses" button 124 on the toolbar 40 from a HTML on the site 16. After entering in the proper user and password information, clicking the login-button 138 (Fig. 7) will take the user to the "Shipping Address" page 206. To add a new shipping address, the user fills in the location information (name, address, city, state, zip code, Internet address, e-mail) into the provided input boxes 50. All input boxes 50 that have an "*" next to them are required fields. Once information has been added, the user clicks on an "Add Address" button 208 provided on the page 206, which runs a script saving the data to a shipping address file, one of the files 33, stored on the local drive 18. To edit an existing address, the user selects a location 209 from a location list box 210 provided on the page 206 by clicking on the location 209 to be edited so that it is highlighted. The user then clicks on an "Edit Address" button 212, which retrieves the information from the shipping address file. The user after making the desired changes, then clicks on the "Save All Addresses" button 214 on the toolbar 40, which runs a script that saves the entered information in the shipping address file. To delete an address, the user selects the location 209 to be deleted from the location list box 210, so that the location is highlighted, and then clicks on a "Delete Address" button 216. Clicking the "delete Address" button 216 runs a script that removes the highlighted location 209 from the shipping location file.

ORDER/UPDATE

Figs. 14a and 14b, illustrate the HTML pages use by the application 4 to review and edit product-ordering information for a customer before being sent to the distributor's system 32 via an FTP session. Fig. 14a depicts an order/update page 218 that lists in a select customer column 220 customers, and their corresponding products ordered listed in a product column 222. To access this page the user clicks on the Order/Update button 126 from the toolbar 40 on any HTML page on the site 16. It is to be appreciated that the order/update page 218 lists only those customer's orders that have not been previously uploaded to the distributor's system 32. Accordingly, multiple customers may be shown in the order/update list provided on the order/update page 218. To upload the order to the distributor's system 32, the user clicks the upload orders button 224, which runs a script that opens a FTP session with the distributor's system and transfers the product order file, one of the files 33. To review an order listed on Order/Update page 218, the privilege user clicks on a customer name 228 listed in the select customer column 220, which takes the user to an order/update form page illustrated by Fig. 14b.

Fig. 14b depicts an order/update form page 230, which enables a privilege user to review a specific customer"' order, to specify delivery information, to add any special instructions to the distributor, and to place the order on-line. As depicted, provided are input boxes 50 in which to edit and enter information. Additionally, shown are the shipping addresses 209 provided in a drop down box in which to select. It is to be appreciated that the default shipping address 209 is the address provided at the top of the list in the shipping address list box 210 (Fig. 13). Further from the order/update form page 230, the privilege user can determine if the shipment is either a normal or a priority order by selecting the priority from a priority deliver drop down box 232. If at any point during the review, the privilege user wishes to go back to the original selections for the order, clicking on a reset button 234 will reset all information back to their previous selections. After the privilege user has reviewed the order and made the necessary changes, the product order is sent to the distributor"' system 32 by clicking on a submit orders button 236.

FUNERAL ARRANGEMENT PROCESS

Referring to Figs. 1517, illustrated are preferred architectural blueprints 300, 302, 304, respectively, that take a family through a funeral arrangement process. It is to be appreciated that these architectural blueprints 300, 302, 304 are visual representations of the preferred embodiment of the structure of site 16 (Fig. 1), which show how elements of the site 16 of the application 4 are link or relate to one another.

From the home page 10 (step 306) of the family advising application 4, a user desiring to arrange for a funeral clicks on the selection room hot button 112 on the navigation toolbar 40, which takes the user to an Introduction information page 308 on site 16 of the application 4. The Introduction information page 308 gives a brief explanation of the process that a user is about to go through in making a funeral arrangement. From here the user will navigate (Step 310) to a linked biographical form page 312, where the user can select the name of a prior customer or input a new name, ID number, date, and classify the call as "At Need"o "Pre Need" (step 314). Once this information is entered, the user will click on the continue button 46 on the toolbar 40 (step 316). The next page to appear is the Family Services Selection Guide form page 318. On this page 318 the user is prompted to complete a number of questions 50 (by selecting radio buttons 54) about the type of funeral service the family is planning to have. This page 318 also includes information buttons 70 that provide more in depth information on the available funeral services (optional step 320) by being linked to a Disposition information page 322, a Cremation information page 324, and a Services information page 326. As illustrated, the Services information page 326 contains digital video clips 328, 330, 332, 334 that explain the benefits of the different types of services. Any number videos clips on different subjects may be provided, but preferably, these digital video clips include a Viewing video 328, a Funeral Ceremony video 330, a Memorial Service video 332, and a Graveside Service video 334. It is to be appreciated that the above-mentioned videos show benefits to a family for each particular service as explained by a grief counselor and which are viewable if the user desires (optional step 336).

From the Family Service Selection Guide form page 318 the user selects (step 338) between a Burial option and a Cremation option. Selecting either the burial path 340 or the cremation path 342 will take the user through the same services pages 344 through 350. Once either the burial path 340 or cremation page 342 has been selected, the user may click on the provided continue button 46 to proceed to the service package page 344 for the desired service.

In going down the service path, the first page that the user will see is a packages page form 344. The packages form page 334 provides the user with choices 54 for various service packages, which is customizable by each individual funeral home. To view detailed description of any listed choices, the user can click on the text of that choice. To select the choice the user clicks on the radio button 56 next to the corresponding choice. To move to the next services form page 346 the user clicks on the "Continue" button 48 on the provided navigation toolbar 40. The user follows the same procedure of selecting choices 56 on the Services form page 346, on the Facility & Transportation form page 248, and on the Merchandise form page 250. Once all services have been selected, if on the Family Service Selection Guide form page 318 the option selected was for the burial path 340 then the user will go to a Family Casket Selection Guide form page 252. However, if the option selected was for the cremation path 342, then the user will go to a Family Cremation Casket from Guide 236.

For a burial, on the Family Casket Selection Guide form page 352 the user selects casket preferences to filter down the range of products for display. Additionally from this page the user can select (optional step 358) to view the Casket information page 360. From page 360 the user can view information, and make further investigations by selecting a Metal Casket information button (not shown) to go down a metal information path 362 and on a Wood Casket information button (not shown) to go down a wood casket path 364. By clicking the metal casket path 362, the user goes to a Metal Casket information page 366. The page 366 has optional hot buttons that can be selected for additional information pages on Bronze Caskets 368, Copper Caskets 370, Stainless Steel Caskets 372, and Steel Caskets 374. Also, digital video clips may be viewed from this page 366 on a Metal Casket Manufacturing Process 376, a Hand Brushing Process 378, and an Interior Finishing Process 380. By selecting the wood casket information path 364, the user goes to a Wood Casket information page 382. From here the user can optionally select to view other information pages containing information on mahogany caskets 384, cherry caskets 386, oak caskets 388, maple caskets 390, poplar caskets 392, and veneer caskets 394. Digital video clips may also be viewed, if desired, from this page 382 concerning a wood finish process 396 and an interior finishing process 398.

After selecting the preferences from a list of desired choices 54 (step 354), a script on the Family Casket Selection Guide form page 352 instructs the search of the products database 28 for those caskets that meet the user defined casket criteria. At completion of the query, the application 4 displays the retrieved product information, one product at a time on a HTML product selection information page 356, in order of the most expensive to the least expensive product. The product information displayed includes a digital image of the product along with the product name, a retail price, a price of services selected, total cost of the funeral incurred so far, and a counter (not shown) that indicates the total number of products that meet that user selected preferences. To see a close up of the product the user may click on the product image, which zooms in on the displayed product image.

Both the Cremation Casket Selection Guide form page 354 and the Cremation Urn Selection Guide form page 356 operate in similar fashion to the Family Casket Selection Guide form page 352. If a cremation casket is selected (optional step 400), then the user will go to a View and Select Cremation Casket information page 402, with an optional detailed information page 404 that is navigated to by a provided hot button. Either in either cases if the Family Cremation Casket selection page is skipped (optional step 406) or not skip, the user will then be presented with the Cremation Urns Selection Guide page 356. From this page 356 the user selects urn product preferences, which then leads (step 408), via a script that performs a query on the database 28, to an Urns Selection information page 410. The urns fitting the entered preferences are displayed one at a time in order of most expensive too least expensive for viewing and selection. From this page 410, if desired a user may select to view a video clip 412 that provides additional information on the manufacturing of the urns.

It is to be appreciated that from both the Casket Selection information page 356 and the Urns Selection information page 410, clicking on the provided Choose selection button 76 for each product displayed orders the product. After ordering the products, clicking on the provided Save & Continue button (step 412) will bring the user to an editable Summary page 414, which is the same ending page for both the burial and cremation paths. On this page 414, pricing adjustments can be made, as well as, editing of cash advance services. Once the statement is finalized, the user clicks on the provided Save & Continue button on the toolbar 40 (step 416) to view a condensed printable summary description page 418 of all selected services and products.

To order the products on-line the user clicks on the provided "Order/Update" button (step 420) on the toolbar 40 of the selection summary description page 418. The user is then taken to the Order Update page 422, which lists the outstanding orders that have not been previously upload to the distributor"' system 32. On this page 422, the user can edit the information as discussed above in the Update/Order section. Once all order information is complete, the user clicks on the "Submit Orders" button (step 424), which starts the FTP session and transmits the order to the distributor system 32 for further processing.

Having described the present invention in detail and by reference to various embodiments thereof, it will be apparent that certain modifications and variations are possible without departing from the scope of the invention defined in the appended claims.

I claim:

What is Claimed is:

1. A computer-implemented method permitting a user to electronically plan a funeral on a computer comprising:
employing on the computer a funeral planning routine comprising processes adapted to generate a funeral plan;
receiving via the computer planning data from the user, said planning data including biographical information, period of execution, and funeral arrangement information;
utilizing said planning data in said funeral planning routine to generate said funeral plan; and
outputting via the computer at least a summary of said funeral plan to the user such that the user may determine whether to revise or accept said funeral plan as represented by said received planning data.

2. The computer-implemented method according to claim 1 wherein if the user decides to revise said funeral plan then the user may edit said planning data, and if the user decides to accept said funeral arrangement plan then said funeral planning routine allocates resources based on said period of execution.

3. The computer-implemented method according to claim 1, wherein said funeral arrangement information includes type of disposition, type of funeral service, location of the funeral, and desired funeral services and/or products.

4. The computer-implemented method according to claim 1, further comprising presenting the user with an electronic selection guide for entering at least a portion of said funeral arrangement information.

5. The computer-implemented method according to claim 1 further comprising retrieving requested information associated with a plurality of products and services.

6. The computer-implemented method according to claim 1 further comprising running a price summary allowing the user to evaluate the immediate monetary effect in order to permit the user to adjust choices accordingly.

7. The computer-implemented method according to claim 1 wherein said summary comprises name of user, selected services and/or products, quantity of selected services and/or products, price, tax, sub-total, cash advance amount, cash advance total, customer total, and combinations thereof.

8. The computer-implemented method according to claim 1 further comprising saving the funeral arrangement plan to a database.

9. The computer-implemented method according to claim 1 further comprising forwarding at least a portion of said funeral arrangement plan to a distributor"' system when said period of execution is at-need.

10. The computer-implemented method according to claim 1 further comprising updating inventory of available products and/or services from a distributor such that said user may selected said available products and/or service to include in said funeral arrangement information.

11. The computer-implemented method according to claim 1 wherein said funeral planning routines are being executed on a computer local to the user.

12. The computer-implemented method according to claim 1 further comprising outputting upon request a price list for funeral products and/or services.

13. The computer-implemented method according to claim 1 wherein said period of execution is either pre-need or at-need.

14. The computer-implemented method according to claim 1 further comprise permitting the user to change said period of execution between a pre-need registration to an at-need order.

15. The method according to claim 1, wherein said funeral arrangement information comprises type of deposition selected among choices comprising burial and cremation.

16. The method according to claim 1, wherein said funeral arrangement information comprises type of service selected among choices comprising viewing, memorial service, funeral ceremony, graveside service, and combination thereof.

17. The method according to claim 1, wherein said funeral arrangement information comprises location of funeral selected among choices comprising funeral home, and other facility.

18. The method according to claim 1, wherein said planning data further includes period of funeral services.

19. The method according to claim 1, wherein said summary comprises currently selected services, currently selected products, currently selected cash advance items, customer information, current quantity and cost, current customer total, and combinations thereof.

20. The computer-implemented method according to claim 1 further comprising maintaining a database containing funeral home information comprises name, distributor account number, shipping address data, internet address, ftp address, contact information, disclosure information, phone, fax, email, state and local tax rates, and combinations thereof.

21. The computer-implemented method according to claim 1, wherein a portion of said planning data is obtained from a presentation to the user of available funeral arrangement products and services and a selection by the user of said available funeral arrangement products and services.

22. The computer-implemented method according to claim 1 wherein at least a portion of said funeral planning routines are being provided to a computer of the user from a server.

23. The computer-implemented method according to claim 10 wherein said updating is via an inventory check with a server of said distributor.

24. The computer-implemented method according to claim 22 further comprising providing a connection between said computer of the user and said server via the Internet.

25. A computer-implemented method permitting a user to electronically plan a funeral on a computer comprising:
employing on the computer a funeral planning routine comprising processes adapted to generate a funeral plan;
retrieving via the computer information requested by the user associated with a plurality of products and services;
receiving via the computer planning data from the user, said planning data including biographical information, period of execution, and funeral arrangement information comprising desired products and services;
utilizing said planning data in said funeral planning routine to generate said funeral plan; and
outputting via the computer at least a summary of said funeral plan to the user such that the user may determine whether to revise or accept said funeral plan as represented by said received planning data.

26. The computer-implemented method according to claim 25, wherein said retrieving is by accessing a database storing said information.

27. The computer-implemented method according to claim 25, wherein said plurality of products and/or services are provided by a plurality of funeral service providers, each of said plurality of funeral service providers is associated with a distinct set of products and services from said plurality of products and services.

28. The computer-implemented method according to claim 26, further comprising communicating with a distributor server to update at least a portion of said information on said plurality of products and services.

29. The computer-implemented method according to claim 25 further comprising preventing the user from seeing out-of-stock products contained in said information.

30. The computer-implemented method according to claim 25 further comprising presenting an electronic selection guide which lists a plurality of selectable user actions for interactively guiding the user in planning the funeral and selecting said desired products and services.

31. The computer-implemented method according to claim 25 further comprising displaying an electronic response page in response to selection of one of a plurality of user actions provided by said funeral planning routine, said electronic response page providing said information on available funeral services and products in a database and enabling selection of said desired products and services from said available funeral services and products.

32. The computer-implemented method according to claim 25 further comprising presenting an electronic selection guide page; displaying a current services page in response to a selected user action for services from said electronic selection guide page and populating said current services page with existing funeral service information contained in a database.

33. The computer-implemented method according to claim 25 further comprising customizing said information as it should appear to the user by updating said information contained in a database with customized information.

34. The computer-implemented method according to claim 25 further comprising:
storing said information in a database;
customizing said information by:
selecting which of said information in said database to display to the user;
customizing said information as it should appear to the user; and
updating said database.

35. The computer-implemented method according to claim 25 further comprising:
storing said information in a database;
updating said database by downloading from a database server updated information in response to a user selection inventory update; and
updating said database with said information update.

36. The computer-implemented method of claim 25 further comprising entering said biographical information on an electronically displayed biographical entry form.

37. The computer-implemented method claim 25 further comprising presenting electronically a package page enabling user selection of various packages of preselected funeral products and/or services.

38. The computer-implemented method of claim 25 wherein said desired products and services include cremation selection, burial selection, transportation selection, caskets selection, urns selection, marker selection, funeral related merchandise selection, and combinations thereof.

39. The computer-implemented method according to claim 25 further comprising forwarding an order generated from said summary to a server of a distributor for processing delivery of said order.

40. The computer-implemented method according to claim 37, further comprising sending a confirmation from said server to the user confirming said order.

41. The computer-implemented method according to claim 25 further comprising displaying a multimedia presentation corresponding to user action for particular information when said user action for said particular information is selected.

42. The computer-implemented method of according to claim 41 wherein said particular information includes urn products, casket products, marker products, funeral related merchandise, explanations of disposition processes, and explanations of services.

43. A funeral arrangement planning system adapted to permit a user to electronically plan a funeral comprising:
a computer running a funeral planning routine comprising processes for generating a funeral arrangement plan for a period of execution;
an input device for inputting to the funeral planning routine planning data, said planning data including biographical information, period of execution, and funeral arrangement information;
a display for presenting visual objects related to said funeral planning routine and said planning data;
a memory device storing information related to funeral products and services;
a communication device for connecting to a remote server of a distributor of said funeral products and services to update said information and to provide an order to said distributor;
said computer utilizes said funeral planning routine to interactively guide the user through the planning of the funeral by accepting funeral arrangement data from the user and, when necessary, accessing said information stored in said memory device and storing said funeral arrangement data to said memory device, and
said computer utilizes said funeral planning routine and said planning data to generate a summary such that the user may determine whether to revise or accept the funeral arrangement plan as represented by said input planning data, if revising then the user may edit any portion of said planning data, and if accepting then said funeral planning routine is capable of sending said order to said distributor.
